(19) United States
(12) Patent Application Publication
(10) Pub. No.: US 2026/0096001 A1
(43) Pub. Date: Apr. 2, 2026

(54) EXTREME ULTRAVIOLET LIGHT SOURCE OBSCURATION BAR AND METHODS

(71) Applicant: ASML Netherlands B.V., Veldhoven (NL)

(72) Inventors: Yue Ma, San Diego, CA (US); Mohsen Benjamin Battoei, San Diego, CA (US); Armin Bernhard Ridinger, San Diego, CA (US); Liza Easo, Riverside, CA (US); Jonathan Anthony Walker, San Diego, CA (US)

(21) Appl. No.: 19/115,993

(22) PCT Filed: Oct. 18, 2023
(86) PCT No.: PCT/EP2023/079073

§ 371 Date: Mar. 27, 2025

Related U.S. Application Data
(60) Provisional application No. 63/420,775, filed on Oct. 31, 2022.

(51) Int. Cl. H05G 2/00

(52) U.S. Cl. CPC H05G 2/0094; H05G 2/0082

(57) ABSTRACT

An extreme ultraviolet (EUV) source includes a source vessel enclosing at least in part a volume in which, when in use, EUV light is transmitted by a collector from a primary focus to an intermediate focus along an optical axis: a shaft, the shaft having a length extending from a first end to a second end of the shaft·the shaft including a passage, the passage extending at least partially along the length of the shaft, the first end of the shaft attached to an interior surface of the source vessel and the second end positioned inside the source vessel; a head (130) connected to the second end of the shaft, the head intersecting the optical axis, the head having an exposed surface (134) exposed to the primary focus, the exposed surface having one or more apertures therein, the one or more apertures being in fluid communication with the passage.

### CROSS-REFERENCE TO RELATED APPLICATIONS

This application claims priority of U.S. application 63/420,775 which was filed on Oct. 31, 2022 and which is incorporated herein in its entirety by reference.

### TECHNICAL FIELD

The present disclosure relates to methods of and apparatuses for generating extreme ultraviolet (“EUV”) radiation from a plasma created in a source vessel by irradiating a target or a target material with a laser, and in particular to apparatuses and methods for controlling a flow within the source vessel of products produced by the irradiation of targets.

### BACKGROUND

Extreme ultraviolet radiation, e.g., electromagnetic radiation having wavelengths of around 50 nm or less (also sometimes referred to as soft x-rays), including radiation at a wavelength of about 13.5 nm, can be used in photolithography processes to produce extremely small features in or on substrates such as silicon wafers. Methods for generating EUV radiation include converting a target material to a plasma state. The target material includes at least one element, e.g., xenon, lithium, or tin, with one or more emission lines in the EUV portion of the electromagnetic spectrum. The target material can be solid, liquid, or gas. In one such method, often termed laser produced plasma (“LPP”), the required plasma can be produced by using a “source” laser, typically a CO₂ laser emitting infrared light at a wavelength at or about 10,600 nanometers (nm), to irradiate with one or more light pulses a target containing one or more EUV line-emitting elements. The plasma is typically produced in a sealed “source vessel” which is typically a vacuum chamber.

### SUMMARY

In some general aspects, an extreme ultraviolet (EUV) source includes a source vessel, enclosing at least in part a volume in which, when in use, EUV light is transmitted by a collector from a primary focus to an intermediate focus along an optical axis: a shaft, the shaft having a length extending from a first end to a second end of the shaft, the shaft including a passage, the passage extending at least partially along the length of the shaft, the first end of the shaft attached to an interior surface of the source vessel and the second end positioned inside the source vessel: a head connected to the second end of the shaft, the head intersecting the optical axis, the head having a surface exposed to the primary focus, the surface having one or more apertures therein, the one or more apertures being in fluid communication with the passage.

Implementations can include one or more of the following features. One or more apertures can be oriented along one or more directions having a component in a direction along the optical axis away from the intermediate focus and a component perpendicular to the optical axis. The one or more apertures can include a plurality of nested ring-shaped apertures. The one or more apertures can include a plurality of non-overlapping holes. The head can be integral with the shaft.

The head can have a cross section, taken perpendicular to the optical axis, which is circular and centered on the optical axis. The head and the shaft can include a refractory material. The refractory material can be a refractory metal. The refractory metal can be tungsten.

The source vessel can include an exhaust opening extending through the source vessel with the exhaust opening positioned, measured along the optical axis, between the collector and the head. The apertures in the exposed surface of the head can be configured to create, when in use and supplied with a flow of gas through the passage, a gas curtain extending from the exposed surface of the head and having a flow direction from the exposed surface of the head toward an edge of the exhaust opening nearest the intermediate focus and/or toward a portion of the interior surface of the source vessel adjacent the edge of the exhaust opening nearest the intermediate focus. The flow direction of the gas curtain can have a component along the optical axis away from the intermediate focus.

The head can have no surfaces perpendicularly facing the intermediate focus. The shaft can have no surfaces perpendicularly facing the intermediate focus.

The EUV source can include a target delivery system configured and positioned to deliver targets including a target material to a primary focus of the collector and a laser configured and positioned to produce a pulsed light beam having a beam waist at or near the primary focus of the collector. The target material can include any one or more of xenon, lithium, and tin. The target material can specifically include tin.

The EUV source can include a supply of a gas connected to the passage, and the gas can be an inert gas or hydrogen. The gas can specifically include hydrogen. The collector can include a central aperture positioned to allow passage of the pulsed light beam along the optical axis toward the primary and intermediate foci of the collector.

The head can be positioned such that no or essentially no direct light from the primary focus is reflected by the collector to the head. The head can shield the intermediate focus from direct light from the pulsed light beam. The head can have an anti-reflection and/or a diffusive geometry facing the primary focus of the collector such that the pulsed light beam is reflected in a diffuse manner from the head rather than concentrated at any location within the source vessel. The anti-reflection and/or diffusive geometry of the head can include a generally convex surface.

The shaft can have no surfaces that are perpendicularly facing the intermediate focus. The shaft can have no surfaces that are perpendicularly facing the primary focus. The shaft can have an elongated cross section when taken in a plane parallel to the optical axis and perpendicular to the length of the shaft, with a long dimension of the cross section lying in a direction generally parallel to the optical axis, and a cross section of the passage in a plane parallel to the optical axis and perpendicular to the length of the shaft can be elongated a direction generally parallel to the optical axis.

The EUV source can also include a target delivery system configured and positioned to deliver targets including a target material to the primary focus of the collector, with the target delivery system including a shroud shielding a path toward the primary focus of the collector, such that an image of the shaft is aligned with an image of the shroud when viewed from the primary focus of the collector in reflection from the collector surface. The image of the shaft can be hidden by the image of the shroud when viewed from the primary focus of the collector in reflection from the collector surface.

The source vessel can include one exhaust opening extending through one side of the source vessel with the exhaust opening positioned, measured along the optical axis, between the collector and the head. The source vessel can include a plurality of exhaust openings extending through the source vessel with the exhaust openings positioned, measured along the optical axis, between the collector and the head. The apertures can be configured to create, when in use and supplied with a flow of gas through the passage, respective gas curtains for each respective one of the plurality of exhaust gas openings, the respective gas curtains having respective flow directions from exposed surface of the head toward an edge nearest the intermediate focus of the respective one of the plurality of exhaust openings and/or toward a portion of the interior surface of the source vessel adjacent the edge nearest the intermediate focus of the respective exhaust opening. The apertures can be configured to create. when in use and supplied with a flow of gas through the passage, a radially extending gas curtain extending from the exposed surface of the head with a flow direction including a radial component perpendicular to and away from the optical axis and an axial component parallel to the optical axis and away from the intermediate focus. The source vessel can include a ring-shaped exhaust opening encircling the source vessel and extending through the source vessel with the ring-shaped exhaust opening positioned, measured along the optical axis, between the collector and the head.

In other general aspects, a method of reducing or preventing deposition on an interior of a source vessel in an extreme ultraviolet (EUV) light source can include: supplying a gas to a passage in an obscuration bar including a shaft and a head, a first end of the shaft supported on an interior surface of a source vessel in an EUV light source, the source vessel surrounding an optical axis of the EUV light source, the optical axis extending from a collector through a primary focus to an intermediate focus, a head of the obscuration bar at a second end of the shaft intersecting the optical axis, the head having an exposed surface exposed to the primary focus, and flowing the gas out through one or more apertures in the exposed surface of the head of the obscuration bar, the one or more apertures in fluid communication with the passage.

Implementations can include one or more of the following features. The one or more apertures can be oriented along one or more directions having a component in a direction along the optical axis away from the intermediate focus and a component perpendicular to the optical axis.

The head can be integral with the shaft of the obscuration bar. The head can have a cross section, taken perpendicular to the optical axis, which is circular and centered on the optical axis. The head can have no surfaces perpendicularly facing the intermediate focus.

The head and the shaft can include or be formed of a refractory material. The refractory material can be a refractory metal. The refractory metal can be tungsten.

The source vessel can include an exhaust opening extending through the source vessel with the exhaust opening positioned, measured along the optical axis, between the collector and the head, and the method can include flowing gas from inside the source vessel through the exhaust opening. The method can include generating a gas curtain of or using the gas flowing out through one or more apertures in the exposed surface of the head, the gas curtain extending from the exposed surface of the head to the exhaust opening and/or to a portion of the inside surface of the source vessel on the intermediate focus side of the exhaust opening. The gas curtain can extend along a direction having a component along the optical axis away from the intermediate focus. The method can include introducing an intermediate-focus-protecting gas flow at or near the intermediate focus flowing toward the collector along the optical axis. Generating the gas curtain can include splitting the intermediate-focus-protecting gas flow at the head and joining the intermediate-focus-protecting gas flow with the gas flowing out through one or more apertures in the exposed surface of the head to form the gas curtain.

The method can include delivering targets including a target material to the primary focus of the collector, the target material having a melting point, irradiating the targets with light pulses at the primary focus of the collector to form a plasma at the primary focus of the collector, with the plasma emitting EUV light, and maintaining at least portion of the source vessel at a temperature or temperatures below the melting point of the target material. Maintaining at least portion of the source vessel at a temperature or temperatures below the melting point of the target material can include maintaining at least a portion of the source vessel at a temperature within the range of from 50° C. to 200° C.

Flowing the gas out through one or more apertures in the exposed surface of the head of the obscuration bar can include suppressing or preventing a flow of gas in a direction away from the collector from passing an exhaust opening, causing the flow of gas in a direction away from the collector to enter the exhaust opening. The method can include suppressing or preventing the flow of gas in a direction away from the collector from passing the exhaust opening during a time period extending 20 milliseconds (ms) or 50 ms or in the range of 20 to 50 ms from a moment of stopping irradiating targets with light pulses in the source vessel. The method can include suppressing or preventing the flow of gas in a direction away from the collector from passing the exhaust opening during a time period extending 20 milliseconds or 150 ms or in the range of 20 to 150 ms from a moment of starting to irradiate targets with light pulses in the source vessel.

The details of one or more implementations are set forth in the accompanying drawings and the description below. Other features will be apparent from the description and drawings, and from the claims.

### DRAWING DESCRIPTION

FIG. 1A is a cross-sectional schematic diagram of aspects of an extreme ultraviolet (EUV) light source.

FIG. 1B is a cross-sectional schematic diagram of the EUV light source of FIG. 1A, rotated 90 degrees about the z axis.

FIG. 1C is a cross-sectional schematic diagram of the EUV light source of FIG. 1B, rotated such that gravity is represented downward in the plane of the page.

FIG. 1D is a cross-sectional schematic diagram of the EUV light source of FIG. 1C, showing the negative effects of excess momentum in a flow.

FIG. 1E is a cross-sectional schematic diagram of the EUV light source of FIG. 1C, showing the beneficial effects of an obscuration bar flow.

FIG. 1F is an enlarged view of the inset of FIG. 1E showing detail of gas flow near the obscuration bar.

FIG. 2 is diagram of an EUV source in use with a photolithography exposure apparatus.

FIG. 3 is a perspective view of an implementation of an obscuration bar that can be positioned in the EUV light source of FIG. 1A, 1B, IC, or 1E.

FIG. 4 is a perspective view of another implementation of an obscuration bar that can be positioned in the EUV light source of FIG. 1A, 1B, IC, or 1E.

FIG. 5 is a cross-sectional view taken along the plane 5-5 as marked on FIG. 4 of an implementation of a shaft of an obscuration bar such as the obscuration bar of FIG. 4.

FIG. 6A is a perspective view of another implementation of an obscuration bar that can be positioned in the EUV light source of FIG. 1A, 1B, IC, or 1E.

FIG. 6B is a perspective view of an implementation the head of the obscuration bar of FIG. 6A.

FIG. 7 is a flowchart of a procedure for reducing deposition on an interior of a source vessel of an EUV light source such at the EUV light source of FIG. 1A, 1B, IC, or 1E.

FIG. 8A is a perspective view of another implementation the head of an obscuration bar.

FIG. 8B is a cross-sectional schematic diagram of a portion of an EUV light source having multiple exhaust ports and exhaust openings, showing a use of the obscuration bar head of FIG. 8A.

FIG. 8C is a cross-sectional view of the EUV light source of FIG. 8B taken along the line and in the direction indicated in FIG. 8B.

FIG. 9 is a cross-sectional view similar to FIG. 8C of an implementation of an EUV light source and obscuration bar head.

FIG. 10 is a cross-sectional view similar to FIG. 8C of an implementation of an EUV light source and obscuration bar head.

FIG. 11 is a cross-sectional view similar to FIG. 8C of an implementation of an EUV light source and obscuration bar head.

FIG. 12A is a cross-sectional schematic diagram of a portion of an EUV light source having a ring-shaped exhaust opening.

FIG. 12B is a cross-section of the EUV light source of FIG. 12A taken along the line and in the direction indicated in FIG. 12A.

### DETAILED DESCRIPTION

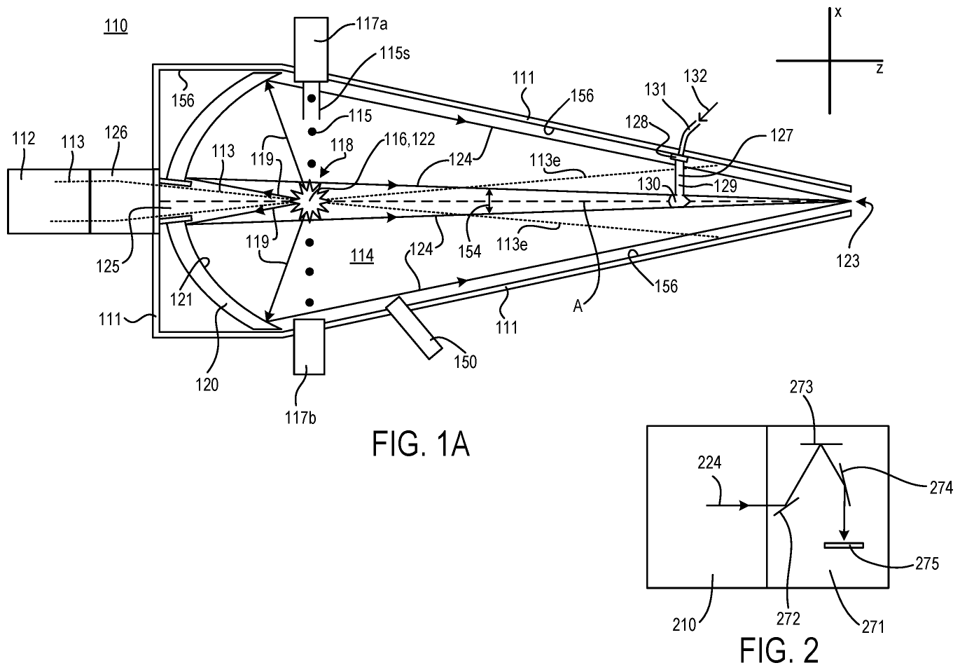

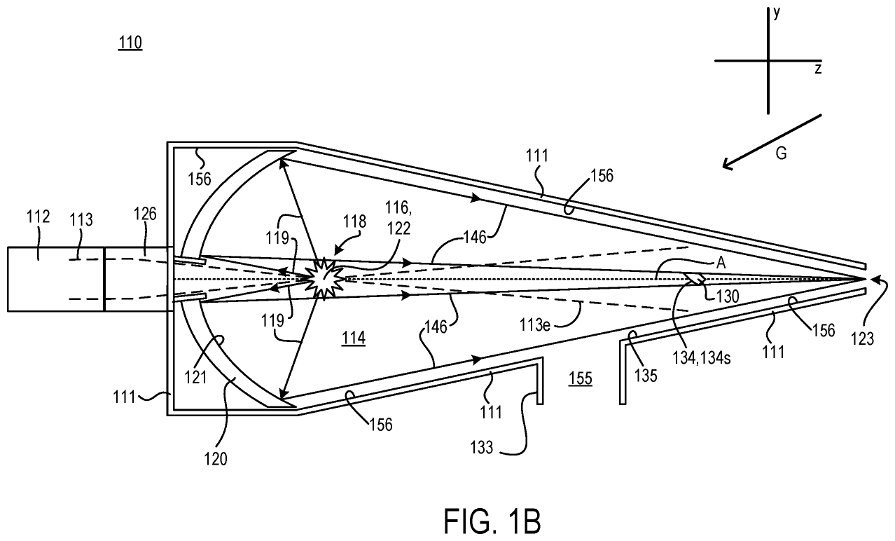

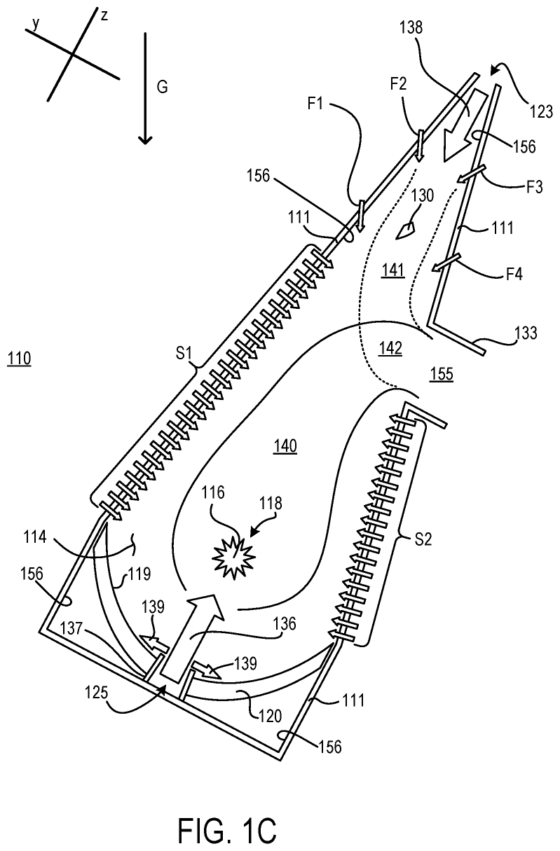

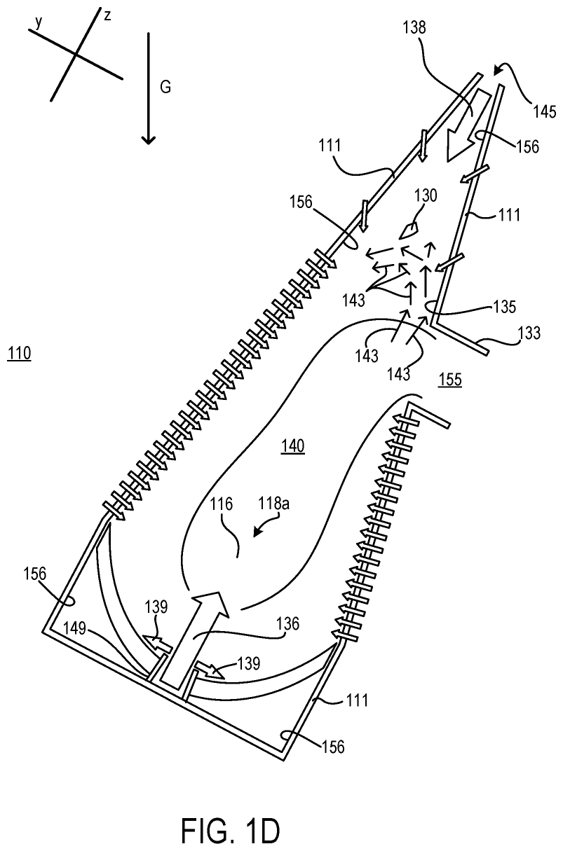

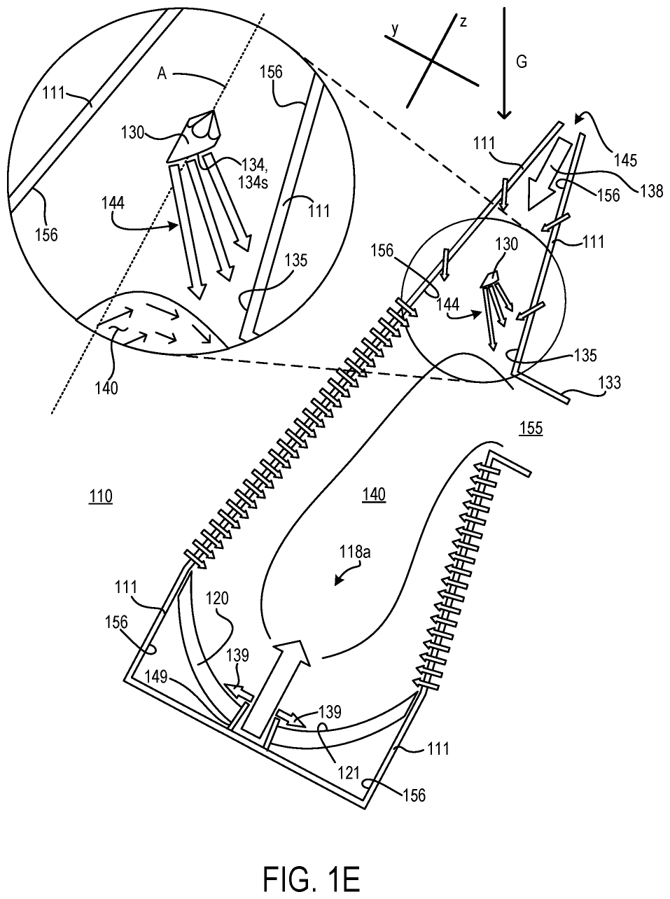

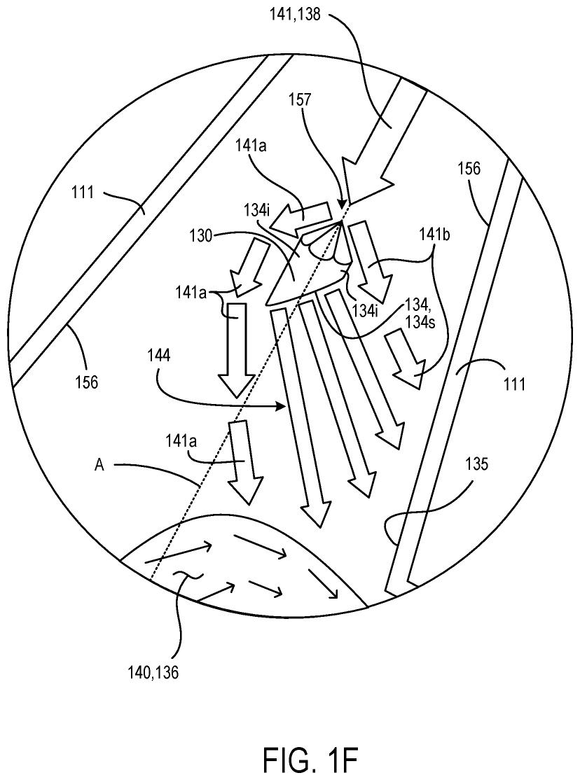

FIG. 1A is a simplified schematic cross-sectional view of some components of an implementation of an LPP EUV light source 110. As shown by the reference coordinate axis in the figure, FIG. 1A is shown in an x-z plane, with x positive in the upward direction in the plane of the page, and z positive to the right in the plane of the page, the z axis aligned with an optical axis A of a collector 120 to be described below.

As shown in FIG. 1A, the EUV light source 110 includes a source laser 112 for generating a beam 113 of light (for example, laser) pulses and delivering the pulsed light beam 113 from the source laser 112 into the interior 114 of a source vessel 111 to individually irradiate targets 115 within an irradiation site 116. The targets 115 travel downward in the plane of the page (in the negative x direction) from a target delivery system 117a to the irradiation site 116. The source vessel 111 has an interior surface 156 surrounding the interior 114.

As also shown in FIG. 1A, the EUV light source 110 includes the target delivery system 117a that delivers the targets 115 into the interior 114 of the source vessel 111 to the irradiation site 116. At the irradiation site 116, the targets 115 individually interact with one or more light pulses (of the light beam 113) to produce a plasma 118 that produces EUV light 119. Light from the plasma 118, positions of the targets 115, and other data can be monitored by one or more metrology devices 150, and the information collected by the one or more metrology devices 150 can be used for control and operation of the EUV light source 110.

The targets 115 can be delivered along at least part of their travel through a target shroud 115s. The shroud 115s can be in the form of a tube (which can have apertures for metrology) or other shielding structure that shields or partially shields incoming targets 115 from gasses and other materials in the interior 114 of the source vessel 111, such that the trajectory of the targets 115 is not excessively disturbed by such gasses or other materials. Unused targets (such as those that are not converted into plasma 118) of the targets 115 can be captured in a target trap 117b.

The targets 115 are or include an EUV emitting target material such as, but not necessarily limited to, tin, lithium, xenon, or combinations thereof. The targets 115 can be in the form of liquid droplets, or alternatively can be solid particles or solid particles contained within liquid droplets. For example, the element tin can be presented as a target in the form of pure tin: a tin compound such as SnBr₄, SnBr₂, SnH₄; a tin alloy, e.g., tin-gallium alloys, tin-indium alloys; or tin-indium-gallium alloys; or a combination thereof.

The EUV light source 110 can also include the collector 120. The collector 120 can be a near-normal incidence collector mirror having the optical axis A and a reflective surface 121. The reflective surface 121 can be in the form of a prolate spheroid (i.e., an ellipse rotated about its major axis), such that the collector 120 has a first or primary focus 122 within or near the irradiation site 116 and a second focus at a so-called intermediate focus 123, with the optical axis A defined as a line extending between them. The source vessel 111 of the EUV light source 110 thus encloses at least in part a volume in which, when the EUV light source 110 and source vessel 111 are in use. EUV light is transmitted by the collector 120 from the primary focus 122 to the intermediate focus 123 along the optical axis A. Reflected EUV light 124 from the collector 120 can be output from the EUV light source 110 at the intermediate focus 123 and input to a device utilizing the EUV light 124, such as a lithography exposure apparatus (as shown in FIG. 2). The collector 120 is formed with an aperture 125 to allow the light beam 113 of light pulses generated by the source laser 112 to pass through the aperture 125 and reach the irradiation site 116. The aperture 125 creates a shadow or voluminous gap 154 along the optical axis A in the reflected EUV light 124 from the collector 120.

In order to reflect the EUV light 119, the collector 120 can be in the form of a multi-layer mirror (MLM), with the reflective surface 121 having a graded multilayer coating with alternating layers of molybdenum and silicon, and in some cases, one or more high temperature diffusion barrier layers, smoothing layers, capping layers and/or etch stop layers. Other surface shapes besides the prolate spheroid can also be used for the reflective surface 121. For example, the reflective surface 121 can alternatively be in the form of a parabola rotated about its major axis. In implementations, the reflective surface 121 can be configured to deliver a beam of EUV light 124 having a ring-shaped or other cross section at the intermediate focus 123. In other implementations, the reflective surface 121 can utilize coatings and layers other than or in addition to those described above.

The collector 120 can be expensive to fabricate. The efficiency and power of the light produced by the EUV light source 110 depend upon the quality of the reflective surface 121 of the collector 120. For these and other reasons, it is desirable to protect the collector 120 from damage to its reflective surface 121.

However, the collector 120 must be placed within the source vessel 111 and proximate or near to the plasma 118 in order to collect and redirect the EUV light 119. Structures within the source vessel 111, including the collector 120, may be exposed to high energy ions and/or particles and vapor of or containing target material. The particles of target material and high energy ions and vapor, which are essentially debris or byproducts from a light-based vaporization or ablation process, can contaminate the collector's exposed reflective surface 121. Particles of target material and energetic ions and vapor can also cause physical damage and localized heating of the reflective surface 121 of the collector 120.

As also shown in FIG. 1A, the EUV light source 110 can include a focusing unit 126 that includes one or more optical elements (not shown) for focusing the light beam 113 to a focal spot or beam waist at or near the irradiation site 116.

FIG. 2 is a diagram showing an implementation of an EUV light source 210 such as EUV light source 110 of FIG. 1A or another EUV source, with a lithography exposure apparatus 271. The lithography exposure apparatus 271 receives EUV light 224 produced by the EUV light source 210 and reflects it in one or more illumination mirrors 272 so as to illuminate a reflective pattern or reticle 273. EUV light reflected from the pattern or reticle 273 is further reflected and reduced by one or more reducing mirrors 274 and irradiated on a substrate or wafer 275 (or on one or more photosensitive layers on the substrate or wafer 275, not shown) to allow the formation of patterned structures in or on the substrate or wafer 275.

Optical elements and sensors within the lithography exposure apparatus 271, as well as the photosensitive layers on the substrate or wafer 275, are typically sensitive to many types or even to any type of radiation. It is therefore important, especially given high power levels produced by the source laser 112 of FIG. 1A, to prevent any part of the beam 113 of light pulses from source laser 112 (including the light beam 113a shown in FIG. 1A that corresponds to the extended portion of the light beam 113 beyond the irradiation site 116) from reaching the intermediate focus 123 and potentially entering a lithography exposure apparatus such as lithography exposure apparatus 271.

To this end, as shown in FIG. 1A, a beam blocking element such as an obscuration bar 127 of the present disclosure can be used. The obscuration bar 127 can include a base 128, a shaft 129 extending from the base 128, and a head 130 supported on the shaft 129. In use of the obscuration bar 127, the head 130 is positioned on the optical axis A of the collector 120, as shown, such that the optical axis A intersects the head 130. Moreover, the head 130 can be positioned and sized to fit within the shadow or voluminous gap 154 in the reflected EUV light 124 from the collector 120. For example, the head 130 can have a cross section, taken perpendicular to the optical axis A, which is circular and centered on the optical axis A and matched to the shadow or voluminous gap 154. This geometry prevents the head 130 from blocking any, or any significant part, of the EUV light 124 that is reflected from the collector 120 and directed toward the lithography exposure apparatus 121, while simultaneously well-protecting the intermediate focus 123 from direct illumination by the light beam 113, 113a of pulses of the source laser 112. Expressed in other terms (regarding positioning in the shadow or gap 154), the head 130 is positioned such that little or no direct light 119 from the primary focus 122 is reflected by the collector 120 to the head 130. The head 130 can also have an anti-reflection and/or a diffusive geometry facing the primary focus 122 of the collector 120, such that light from the source laser 112 that reaches the head 130 is thereby reflected in a diffuse manner from the head 130, rather than concentrated at any location within the source vessel 111. The anti-reflection and/or diffusive geometry of the head 130 can include a generally convex surface exposed to the collector 120.

In source vessels in which a target shroud 115s is used, as shown, the shaft 129 of the obscuration bar 127 can be aligned with the shroud 115s, that is, it can be positioned as much as possible within a shadow created by the shroud 115s in the reflected EUV light 124. Expressed in other terms, an image of the shaft 129 can be aligned with an image of the shroud 115s, when viewed from the primary focus 122 of the collector 120 in reflection from the collector surface 121. In some implementations, the shaft 129 can be completely hidden in the shadow of the shroud 115s, as when the image of the shaft 129 is hidden by the image of the shroud 115s when viewed from the primary focus 122 of the collector 120 in reflection from the collector surface 121. This arrangement reduces or eliminates EUV light 124 being prevented from exiting the EUV light source 110 by the shaft 129. A gas conduit 131 is connected to the base 128 of the obscuration bar 129 and to a source (not shown) of gas, such as H₂ gas 132, allowing the obscuration bar 127 to be used to supply gas to the interior 114 of the source vessel 111 at or near the center or optical axis A of the source vessel 111, as will be shown and discussed in more detail below.

FIG. 1B is a simplified schematic cross-sectional view of the EUV light source 110, rotated 90 degrees around the optical axis A to show a cross section in a y-z plane, with positive y upward in the plane of the page and positive z to the right, as indicated by the reference coordinate axis. When in use, the EUV source 110 can be inclined with respect to gravity as indicated by the gravity vector G, lying within or parallel to the y-z plane as shown. In this view, the shaft 129 and the base 128 of the obscuration bar 127 are behind the head 130 into the page. Also in this view, an exhaust port 133 and an associated exhaust opening 155 are visible. As shown, the exhaust port 133 is a structure that extends from the source vessel 111 and defines the exhaust opening 155 that is in fluid communication with, and extends out from, the interior 114 of the source vessel 111. Gases and entrained ions, vapor, and debris can be evacuated from the source vessel 111 by one or more vacuum pumps (not shown) through the exhaust opening 155 of the exhaust port 133. The exhaust opening 155 is positioned, measured along the optical axis A, between the collector 120 and the head 130.

As also shown in FIG. 1B, the head 130 of the obscuration bar 127 includes a surface or “exposed surface” 134 exposed to the primary focus 122. The exposed surface 134 can be or can include a slanted surface 134s, meaning a surface that is not perpendicular to the axis A, and can be facing generally in the direction of the exhaust opening 155 of the exhaust port 133 and/or in the direction of a portion 135 of the interior surface 156 of the source vessel 111 on the intermediate focus side of the exhaust opening 155, to be shown and discussed in more detail below.

FIG. 1C is another cross section of the EUV light source 110 in the y-z plane, but with the gravity G vector now oriented downward in the plane of the page and with various gas flows that can be used in the EUV light source 110 represented in the figure by outline-style arrows.

Referring to FIG. 1C, gas flows such as flows of hydrogen (H₂) gas at pressures in the range of about 50 to about 300 Pa can be used within the source vessel 111 as a buffer gas for debris and/or vapor control. Given that a vacuum is needed in the interior 114 the source vessel 111 to avoid gas molecules excessively absorbing the EUV light, it would be difficult to protect the collector 120 adequately from target material debris and vapor emanating from the irradiation site 116 without the use of gas flows. Hydrogen (H₂) is relatively transparent to EUV radiation having a wavelength of about 13.5 nm, and so is generally preferred over other candidate gases such as helium, argon, and other gases that exhibit a higher absorption at about 13.5 nm.

H₂ gas can be introduced into the source vessel 111 to slow down and guide energetic debris (ions, atoms, and clusters) of target material created by irradiation of targets 115 and irradiation site 116 and by the resulting plasma 118. The debris is slowed down by collisions with the gas molecules. A flow 136 of H₂ gas at the center aperture 125 of the collector 120 can be used for this purpose. Sometimes known as a “cone flow” 136, the flow 136 can be guided by a tube or nozzle 137 or the like from the aperture 125 at the center of the collector 120 toward the irradiation site 116 at which the plasma 118 is repeatedly created. This direction is counter to a debris trajectory from the irradiation site 116 toward the collector 120, and the cone flow 136 thus serves to reduce damage to the collector 120 caused by vapor deposition, implantation, and deposition of sputtered target material.

When targets 115 that are tin or tin-containing are used, the use of hydrogen gas (such as in the cone flow 136) with such targets 115 results in another potential source of contamination in the source vessel 111. This is the ejection or “spitting” of molten tin, from surfaces in the vessel coated or subject to coating with molten tin, when hydrogen bubbles form and grow in or under the molten tin and then burst.

One way to prevent tin spitting is to prevent molten target material from accumulating on a surface in the source vessel 110 is by keeping the surface below or well below the melting point of the target material, which for tin is about 232° C. For example, some portions of the interior surface 156 of the source vessel 111 can be maintained at a temperature below 232° C., such as a temperature in the range of 50° C. to 110° C. Any tin which deposits on such a surface is kept in solid form and prevents or resists spitting.

But deposition on cold surfaces also shortens the length of service intervals of an EUV source such as EUV source 110. Growth of deposits on cold surfaces and accumulation of liquid tin on hot surfaces can be reduced by the use of additional gas flows.

A gas flow that is often referred to as an umbrella flow 139 can be directed along the surface of the collector 120 (from outlets not shown). So-called showerhead flows, in which gas flows through multiple parallel apertures generally perpendicular to the surface to be protected, such as showerhead flow S1 and showerhead flow S2, can be provided in areas of the source vessel 111 nearest the collector 120. In additional regions such as regions near the intermediate focus 123, protective gas flows parallel to, or having a component of flow directed parallel to, the surface to be protected can be introduced through apertures aimed in directions having a component along or parallel to the surface to be protected. For example, gas flows such as gas flows F1, F2, F3, and F4 can be introduced to protect the interior surface 156 of the source vessel 111 in regions near the intermediate focus 123.

A gas flow often referred to as a dynamic gas lock (“DGL”) is one or more gas flows used to prevent any material leaving the EUV source 110 in the region of the intermediate focus 123. A DGL can produce a gas flow such as DGL flow 138 from the area of the intermediate focus 123 toward the irradiation site 116, which flow 138 can also be termed an “intermediate-focus-protecting” gas flow 138.

A stable guided flow 140 flowing away from the collector 120 can be formed mainly by the cone flow 136, together with the umbrella flow 139 and the showerhead flows S1 and S2 (and optionally others not shown). The solid curved lines in FIG. 1C illustrate an example of the guided flow 140. This guided flow 140 helps contain and carry away from the collector 120 materials, including vapor, ions, and micro and nanoparticles, generated from the targets 115 during production of plasma 118. An opposing flow 141 moving from the intermediate focus 123 toward the collector 120 can be formed mainly by the DGL flow 138, together with flows such as flows F1, F2, F3, and F4 (and optionally others not shown). The dotted curved lines in FIG. 1C illustrate an example of the opposing flow 141.

Given the low pressures used within the source vessel 111, pressure differentials at the exhaust opening 155 of the exhaust port 133 are not large. But a small pressure differential at the exhaust opening 155 produced by vacuum pumping the exhaust port 133, together with a flow momentum balance between the guided flow 140 and the opposing flow 141 at a merging region 142 of the two flows 140, 141, with the merging region 142 being near the exhaust opening 155, can create a stable guided flow of target material byproducts entrained and contained in the guided flow 140 into the exhaust opening 155 without the target-material byproducts substantially contacting any inner surfaces of the source vessel 111.

FIG. 1D shows the cross section of the EUV light source 110 of FIG. 1C but with the gas flow 140 no longer repeatedly receiving and carrying vapor, ions, and micro and nanoparticles produced from the targets 115 used in the plasma production process. This is represented in part in FIG. 1D by an absence 118a of plasma 118 at the irradiation site 116 in the source vessel 111.

Plasma production can be stopped for various reasons. To control the amount of radiation (“exposure dose”) received by a given exposure site on a wafer such as wafer 275 (FIG. 2), the power of the EUV light 119, 124 (FIGS. 1A, 1B) produced by an EUV light source such as EUV light source 111 from each light pulse can be detected and the total power for delivered to that site can be calculated in real time. Once a desired exposure dose level has been reached or exceeded, further light pulses can then be immediately mis-timed so that in the source vessel 111, targets 115 are not hit by the light pulses for as long as that exposure site is positioned for exposure. This results in a sudden cessation of plasma production in the source vessel 111. Sudden stopping (and starting) of plasma production can also occur during moving from one exposure site to the next on a wafer, or during moving from one wafer to the next, or even in lithographic techniques involving lower-than-standard time rates of exposure.

Referring again to FIG. 1D, when successive targets 115 are continually being irradiated by light pulses of the light beam 113 from the source laser 112 at the irradiation site 116 (as in FIG. 1C), vapor, micro and nanoparticles and other debris, and ionized plasma are being repeatedly produced at and near the irradiation site 116 in the source vessel 111 and thus effectively injected or deposited into the conc flow 136 at the primary focus 122 of the collector 120. The net momentum of the injected matter is low or nearly zero, as the energy and momentum of the plasma 118 and associated material tends to travel and/or radiate in all directions. The injected matter thus reduces the overall momentum of the conc flow 136 and the guided flow 140 (formed in part from the cone flow 136) carrying the injected matter away from the collector 120 and toward the exhaust port 133.

When plasma production stops, such as during stepping, adjustments, or other changes in an associated lithography exposure device, the light pulses of the light beam 113 stop hitting targets 115, and the material of the successive targets 115 simply passes through the focus of the collector 120 on its way to the target trap 117b (FIG. 1A). This non-irradiated target material is thus not injected into and entrained in the cone flow 136 and the guided flow 140. Without the presence of matter repeatedly injected at the irradiation site 116 by plasma production there, the momentum of the cone flow 136 and of the flow 140 can be too great to maintain its normal balanced flow path into the exhaust port 133 (or too great to be balanced by opposing flow 141 shown in FIG. 1C). As shown in FIG. 1D, a flow (or “breakout flow”) 143 can pass the exhaust port 133 (or in other words, flow can pass beyond or escape from the normal path of flow 140 out the exhaust port 133). It might be thought that when plasma production stops, target-related vapor and debris are no longer contained in the flow 140 and that breakout flow 143, occurring when plasma is not being produced, would not cause contamination in the source vessel 111. But when plasma production first stops, target-derived vapor and debris are still entrained in the flow 140 from the most recent plasma production, and breakout flow 143 can carry this vapor and debris beyond the exhaust opening 155. Further, when just beginning or restarting plasma production, target material is just beginning to be entrained again in what is at first a high average momentum flow 140, and thus a breakout flow 143 containing target materials can occur at plasma startup also.

When a breakout flow 143 contains target-related materials, deposition or contamination can be produced on the portion 135 of interior surface 156 of the source vessel 111 on the intermediate focus side of the exhaust port 133. The breakout flow 143 or flow 143, after passing the exhaust opening 155, can also move in various other directions, potentially causing unsteady flow patterns in the source vessel 111 and producing contamination in other regions within the interior 114 or at other areas of the interior surface 156.

As shown in the cross section of the EUV light source 110 of FIG. 1E, in an aspect of the present disclosure, the problem of the breakout flow 143 from flow 140 is prevented or reduced by the use of an obscuration bar gas flow 144 provided into the source vessel 111 from the exposed surface 134 of the head 130, or from the exposed surface 134 in the form of the slanted surface 134s, of the head 130 of the obscuration bar 127 (FIG. 1A). As shown in the inset in FIG. 1E, the obscuration bar gas flow 144 flows in a direction that includes at least two components, a first component being toward the portion 135 of the internal surface 156 of the source vessel 111 on the intermediate focus side of the exhaust port 133, and a second component toward the collector 120 along the optical axis A. Having the flow 144 originate from the exposed surface 134 and run in a direction including these two components helps ensure that the momentum of the flow 144, together with the momentum of opposing flow 141 (FIG. 1C) made up of mainly of DGL flow 138 but potentially including other flows such as flows F1-F4, is sufficient to prevent or substantially prevent the flow 140, made up mainly of the cone flow 36, from passing the exhaust opening 155, keeping the flow 140 within its desired pattern travelling from the collector 120 or from the irradiation site 116 into the exhaust opening 155. The obscuration bar gas flow 144 can be left “on” both when plasma is being produced at the irradiation site 116 (such as shown in FIG. 1C) and when plasma is not being produced (such as shown in FIG. 1D), removing or reducing any need to quickly change or rebalance the flows within the source vessel 111. The obscuration bar gas flow 144 can effectively form a gas curtain having a flow direction from the exposed surface 134 of the head 130 toward an edge of the exhaust opening 155 nearest the intermediate focus 123 and/or toward a portion 135 of the interior surface 156 of the source vessel 111 adjacent the edge of the exhaust opening 133 nearest the intermediate focus 123.

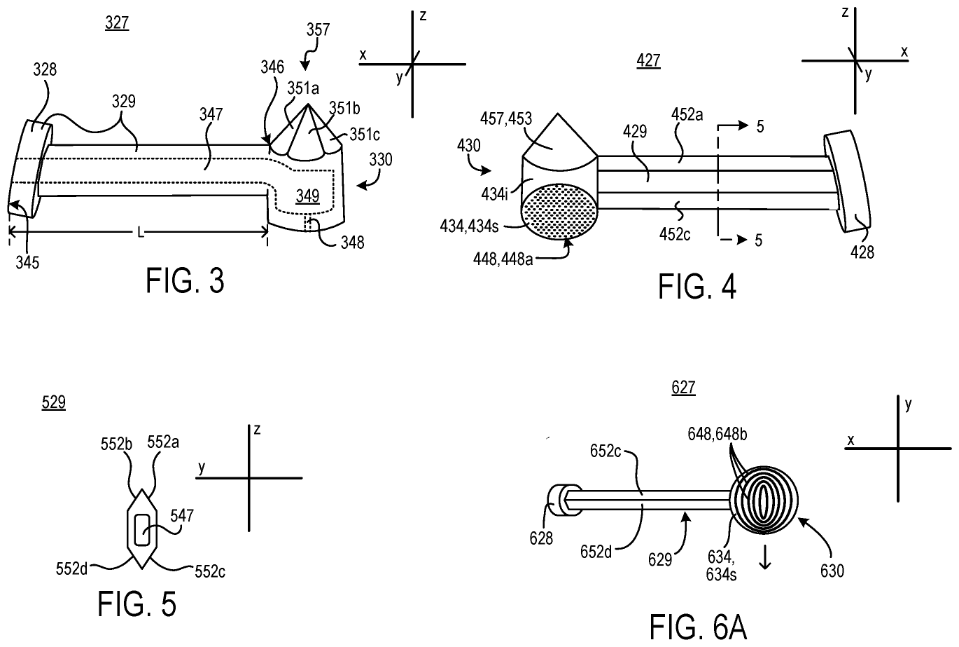

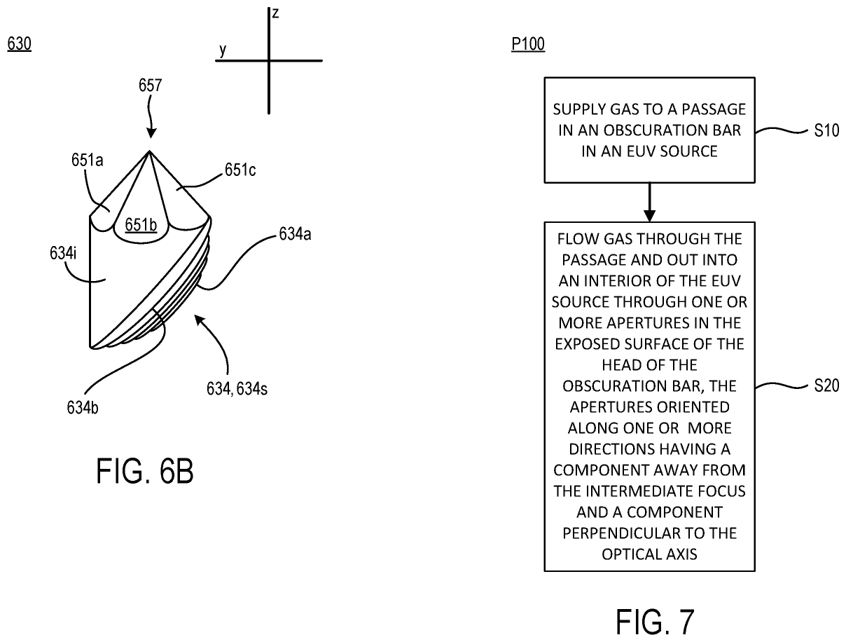

Referring to FIG. 1F, which is an enlarged view of the inset view of FIG. 1E, the intermediate-focus-facing surface 157 of the head 130 of the obscuration bar 127 can, in some implementations, be symmetrical about the optical axis A. In the example of FIG. 1F, the head 130 has a symmetrical pattern of facets (facets shown in more detail below in FIGS. 3 and 6A below) on its intermediate-focus-facing surface 157. Symmetry about the optical axis A tends to divide evenly the opposing flow 141 (or the DGL flow 138, the main component of opposing flow 141) into divided flows such as flows 141a and 141b shown in the plane of the figure. Because the obscuration bar flow 144 is introduced through the exposed surface 134 of the head 130, rather than through a side surface 134i, the obscuration bar flow 144 does not significantly push the divided flows such as flows 141a and 141b away from the side surface 134i of the head 130 and toward the interior surface 156 of the source vessel 111. An approximately even division of the opposing flow 141, together with an obscuration bar flow 144 introduced through the exposed surface 134 of the head 130 rather than through the side surface 134i, helps preserve stability of the opposing flow 141 and allows the divided opposing flows such as flows 141a and 141b to flow together with the obscuration bar flow 144 to help guide the flow 140 (and flow together with it) into the exhaust opening 155 (seen in FIG. 1E). The divided opposing flows such as flows 141a and 141b can thus assist in generating a gas curtain. By splitting the opposing flow 141 (or the DGL flow 138 or “intermediate-focus-protecting” flow 138) at the head 130, effectively joining the intermediate-focus-protecting gas flow 138 with the obscuration bar gas flow 144 flowing out through one or more apertures in the exposed surface of the head 130, a gas curtain can be formed with momentum sufficient to prevent or reduce breakout flows 143.

FIGS. 3, 4, and 6A show various implementations of obscuration bar(s) 127 according to the present disclosure. FIG. 3 is a perspective view of an obscuration bar 327, which is an implementation of the obscuration bar 127 of FIG. 1A. As understood from the description above of FIG. 1A, the obscuration bar 327 is used in the context of an EUV light source 110 including a source vessel 111 enclosing, an interior 114 of the EUV source vessel 111 in which, when in use. EUV light 146 is transmitted from the collector 120 to the intermediate focus 123 along the optical axis A. As shown in FIG. 3, the obscuration bar 327 includes a shaft 329 and a head 330. The head 330 can be attached to the shaft 329 or can be integral with the shaft 329, such as when they are formed together by machining from a single block or by continuous 3-D printing. The shaft 329 can include a base 328 that, if present, can also be integral with the shaft 329.

As represented by the dashed lines in FIG. 3, the obscuration bar 327 also defines or includes a gas passage 347 extending along the direction of the length L of the shaft 329. In the implementation shown, the passage 347 is enclosed inside the shaft 329.

The head 330 and the shaft 329 can include or be formed of a refractory material, such as an oxide, nitride, or carbide ceramic, for example, or a refractory metal. Molybdenum and tungsten are two metals that can be used. Tungsten is useful for its very high melting point and relatively high thermal conductivity.

As shown in FIG. 3, the shaft has a length L extending from a first end 345 to a second end 346 thereof. In use or in position for use, the first end 345 is attached, at the base 328 in this implementation, to the source vessel 111 (as in FIG. 1A for obscuration bar 127). The head 330 is connected to the second end 346 of the shaft 329, and when in use or positioned for use (as in FIG. 1A for obscuration bar 127), the head 330 intersects the optical axis A of the collector 120. The head 330 also has one or more apertures 348 therein, which are in fluid communication with (that is, fluidically connected to) the passage 347, in this implementation, via a chamber 349 inside the head 330.

In the implementation of FIG. 3, multiple angled facets (of which facets 351a, 351b, 351c are shown) are positioned symmetrically on the intermediate-focus-facing surface 357 of the head 330. These facets ensure that, when the obscuration bar 327 is in use or positioned for use, the head 330 has no surfaces perpendicularly facing the intermediate focus 123 (see e.g., FIGS. 1A and 1E and the FIG. 1E inset). Moreover, the surfaces exposed to the intermediate focus are at angles far from perpendicularly facing the intermediate focus, such as greater than 30, or even greater than 45 degrees from perpendicularly facing the intermediate focus. This geometry reduces the likelihood of spitting in the direction of the intermediate focus 123 if the intermediate-focus-facing surface of the head 330 should become coated with liquid tin. The symmetrical arrangement of the facets also promotes stability of the opposing flow 141 moving around the head 330 (FIGS. 1C and 1F) as described above with respect to FIG. 1F.

FIG. 4 shows an obscuration bar 427, which is another implementation of the obscuration bar 127 of FIG. 1A. Shown in FIG. 4 is a perspective view that is 180 degrees rotated from the perspective view of FIG. 3, such that an exposed surface 434 of the head 430, in the form of a slanted surface 434s of the head 430, is visible (sec. e.g., FIG. 1E and the FIG. 1E inset showing the exposed surface 134 in the form of the slanted surface 134s of the head 130 of obscuration bar 127). A plurality of apertures 448 are present in the exposed, slanted surface 434, 434s, and not in a side surface 434i, in the form of a plurality of non-overlapping holes 448a.

In the implementation of FIG. 4, the intermediate-focus-facing surface of the head 430 has a conical surface 453. Similarly to the facets 351a, 351b, 351c in the implementation of FIG. 3, this conical surface 453 ensures that the head 430 has no surfaces perpendicularly facing the intermediate focus 123. Moreover, the conical surface 453 can be exposed to the intermediate focus as at angles far from perpendicularly facing the intermediate focus, such as greater than 30, or even greater than 45 degrees from perpendicularly facing the intermediate focus. Furthermore, in FIG. 4, the shaft 429 has facets 452a and 452b (not shown) on an intermediate-focus-facing surface of the shaft 429 and facets 452c and 452d (not shown) on a collector-facing surface of the shaft 429. Thus, in this implementation, the shaft 429 lacks surfaces that perpendicularly face the intermediate focus 123, and lacks surfaces that perpendicularly face the collector 120 or the primary focus 122 near the collector 120.

As will be understood from FIG. 4, the apertures 448 are typically essentially perpendicular to the exposed, slanted surface 434, 434s. Specifically, when the obscuration bar 427 is in use or mounted for use, the apertures 448 are oriented along one or more directions having a component in a direction along the optical axis A away from the intermediate focus 123, and a component perpendicular to the optical axis A. The exposed, slanted surface 434, 434s can be convex, which can aid in diffusing any reflections of light from the source laser 112. A convex exposed, slanted surface 434, 434s can also allow for production of a wider region of gas flow from apertures 448 in the form of holes generally perpendicular to the exposed, slanted surface 434, 434s. It should be noted that other implementations are possible, such as implementations omitting the slanted surface 434s in favor of slanted apertures in the exposed surface 434 aiming in about the same direction(s) as apertures 448.

FIG. 5 is a cross-sectional view of an implementation of a shaft 529 similar to the shaft 429, such as if taken along the line 5-5 indicated in FIG. 4. The shaft 529 includes facets 552a, 552b, 552c, and 552d, which are similar to the facets of FIG. 4. Moreover, the shaft 529 defines an internal passage 547, similar to the internal passage 347 of FIG. 3. As shown in the implementation of FIG. 5, the shaft 529 has an elongated cross section when taken in a plane parallel to the optical axis A (i.e., parallel to the “z” direction) and perpendicular to the length of the shaft 529, with a long dimension of the cross section lying in a direction generally parallel to the optical axis (i.e., generally parallel to the “z” direction). This shape of the shaft 529 with elongation in the “z” direction allows the shaft 529 to be thin in the x-y plane to better hide within the shadow of the target shroud 115s, if present, while still allowing adequate flow of gas in the passage 547, which is also elongated in the “z” direction.

FIG. 6A is a perspective view of an obscuration bar 627, which is another implementation of obscuration bar 127 (and head 130) of FIGS. 1A-IE. The view in FIG. 6A, as can be seen from the reference coordinates, is taken upward along the “z” axis, or in other words upward along optical axis A. As can be seen in FIG. 6A, a head 630 has a circular cross section when viewed from along the optical axis A. In this implementation, apertures 648 take the form of oval nested ring-shaped apertures 648b in the exposed surface 634, and not in a side surface 634i. The exposed surface 634 having the apertures 648 is again a slanted surface 634s, such that flow from the ring-shaped apertures 648b has components in both the negative “z” and the negative “y” directions, as suggested by the arrow below the head 630. A shaft 629 and a base 628 are similar to some of the other implementations discussed above. Moreover, the shaft 629 includes facets 652c and 652d on its surface, such facets facing the negative “z” direction, or toward the collector 120 of FIGS. 1A-1E. As in other implementations, the exposed, slanted surface 634, 634s can have overall a convex shape. This optional overall convex shape of the exposed, slanted surface 634, 634s is shown in FIG. 6B, in a perspective view of the head 630 of the obscuration bar 627 of FIG. 6A, viewed along the positive x axis as shown by the reference coordinates in the figure. As seen in FIG. 6B, a portion 634a of the exposed, slanted surface 634, 634s near inner ones of the ring apertures protrudes more than a portion 634b the exposed, slanted surface 634, 634s near outer ones of the ring apertures 648b, giving an overall convex shape to the exposed, slanted surface 634, 634s. As in FIG. 3, multiple facets, of which 651a, 651b, and 651C are visible, are present on the intermediate-focus-facing surface 657 of the head 630.

Referring to FIG. 7, a procedure P100 is performed for preventing unwanted deposition in a source vessel 111 of an EUV light source 110. In a step S10, a gas 132 (FIG. 1A) is supplied to a passage 347 within an obscuration bar 127, 327, 427, 627 including a shaft 129, 329, 429, 629 and a head 130, 330, 430, 630 in an EUV light source 110. A first end 345 of the shaft 129, 329, 429, 629 is supported on an interior surface 156 of the source vessel 111 in an EUV light source 110. The source vessel 111 surrounds an optical axis A of the EUV light source 110, and the optical axis A extends between a collector 120 and an intermediate focus 123 of the EUV light source 110. The obscuration bar 127, 327, 427, 627 includes a head 130, 330, 430, 630 at a second end 346 of the shaft 129, 329, 429, 629, that intersects the optical axis A and includes an exposed surface 134, 434, 634 exposed to the primary focus 122. Next, in step S20, the gas 132 is flowed through the passage 347 of the obscuration bar and out of the head and into an interior 114 of the source vessel 111 through one or more apertures 348, 448, 648 in the exposed surface 134, 434, 634 of the head 130, 330, 430, 630 and/or in the shaft 129, 329, 429, 529, 629 of the obscuration bar 127, 327, 427, 627. The apertures 348, 448, 648 can be oriented along one or more directions having a component away from the intermediate focus 123 and a component perpendicular to the optical axis A.

In implementations of the procedure P100, the head 130, 330, 430, 630 can be integral with the shaft 129, 329, 429, 529, 629 of the obscuration bar 127, 327, 427, 627. The head 130, 330, 430, 630 can have a cross section, taken perpendicular to the optical axis A, which is circular and centered on the optical axis A. The head 130, 330, 430, 630 can be devoid of surfaces perpendicularly facing the intermediate focus 123. The head 130, 330, 430, 630 and the shaft 129, 329, 429, 529, 629 can include or be formed of a refractory material. The refractory material can be an oxide, nitride, or carbide ceramic, for example, or a refractory metal. The metal can be molybdenum or tungsten. The refractory metal can be tungsten.

In implementations of the procedure P100, the source vessel 111 can include an exhaust opening 155 defined by an exhaust port 133, the exhaust opening 155 extending through the source vessel 111 with the exhaust opening 155 positioned, measured along the optical axis A, between the collector 120 and the head 130. The procedure P100 can further include flowing gas from inside the source vessel 111 out through the exhaust opening 155. The procedure P100 can include generating a gas curtain at least partly from or with the gas 132 flowing out through one or more apertures 348, 438, 638 in the exposed surface 134, 434, 634 of the head extending to the exhaust opening 155 and/or to the portion 135 of the interior surface 156 of the source vessel 111 on the intermediate focus side of the exhaust opening 155. The gas curtain can extend along a direction having a component along the optical axis A away from the intermediate focus 123. The procedure P100 can include introducing an intermediate-focus-protecting gas flow in the form of DGL flow 138 at or near the intermediate focus 123, flowing toward the collector 120 along the optical axis A. Generating the gas curtain can include splitting the intermediate-focus-protecting gas flow 138 at the head 130, 330, 430, 630 and joining the intermediate-focus-protecting gas flow 138 with the gas flowing out through one or more apertures 348, 448, 648 in the exposed surface 134, 434, 634 of the head 130, 330, 430, 630 to form the gas curtain.

Implementations of the method can include delivering targets 115 including a target material to the primary focus 122 of the collector 120, the target material having a melting point, and irradiating the targets 115 with light (for example, laser) pulses at the primary focus 122 of the collector 120 to form a plasma 118 at the primary focus 122 of the collector 120, the plasma 120 emitting EUV light 119, and maintaining at least portion of the source vessel 111 at a temperature or temperatures below the melting point of the target material. At least a portion of the source vessel 111 can be maintained at a temperature below 232° C. or below 200° C. such as within the range of from 50° C. to 200° C. or 50° C. to 150° C. or even 50° C. to 110° C.

In implementations of the method, flowing the gas 132 out through one or more apertures 348, 448, 648 in the exposed surface 134, 434, 634 of the head 130, 330, 430, 630 of the obscuration bar 127, 327, 427, 627 can include suppressing or preventing a flow of gas 140 in a direction away from the collector 120 from passing an exhaust opening 155, causing the flow of gas 140 in a direction away from the collector 120 to enter the exhaust opening 155. Suppressing or preventing the flow of gas 140 in a direction away from the collector 120 from passing the exhaust opening 155 can occur, for example, during a time period extending 20 milliseconds (ms) or 50 ms or within a range of 20 to 50 ms from a moment of stopping irradiating targets 115 with light pulses in the source vessel 111. Suppressing or preventing the flow of gas 140 in a direction away from the collector 120 from passing the exhaust opening 155 can also occur, for example, within a time period extending 20 ms or 150 ms or within a range of 20 to 150 ms from a moment of starting to irradiate targets with light pulses in the source vessel.

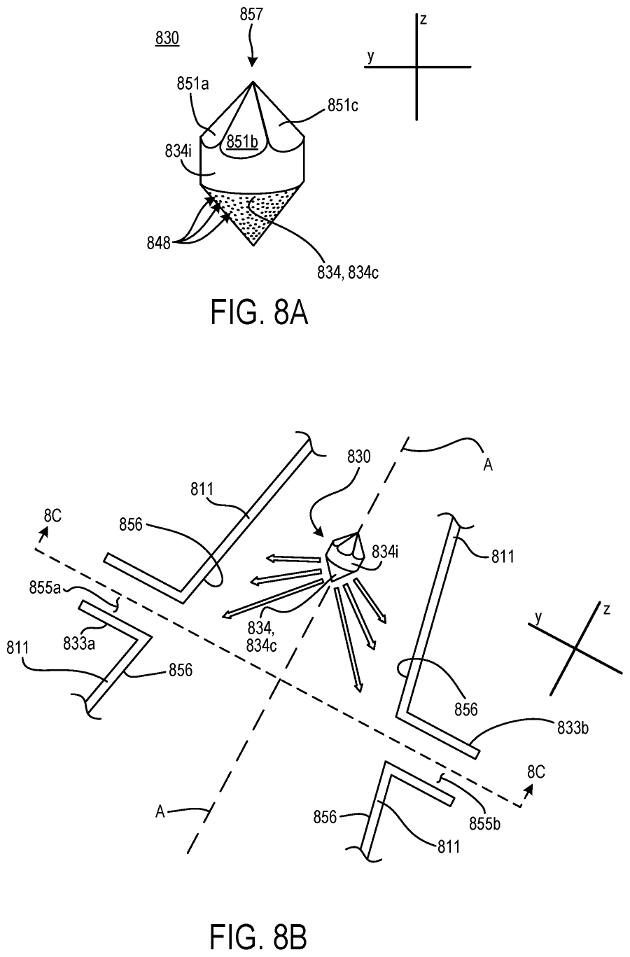

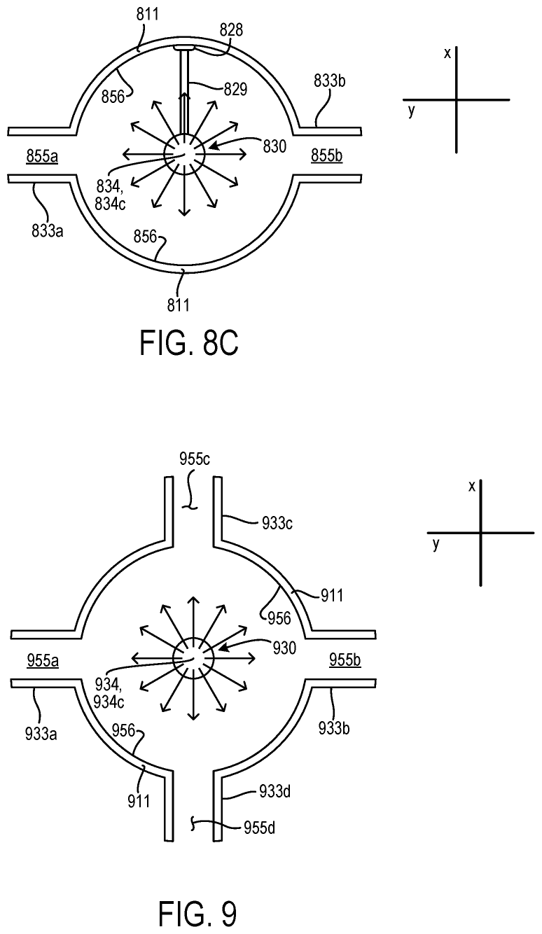

FIG. 8A is a perspective view of another implementation of a head 830 of an obscuration bar that can be positioned within an EUV source vessel 811 shown in partial cross-section in FIG. 8B. FIG. 8C is a cross-sectional view of the source vessel 811 of FIG. 8B taken along the section line and direction indicated in FIG. 8B. The head 830 of the obscuration bar can be supported on a shaft 829 as shown in FIG. 8C. The shaft 829 is attached to an inner surface 856 of the source vessel 811, and can include a base 828 that can facilitate attachment.

Referring to FIGS. 8A-8C, apertures 848 in the head 830 of this implementation are positioned in an exposed surface 834 in the form of a conical surface 834c. As in the case of the head 330 of FIG. 3, multiple facets, of which 851a, 851b, and 851c are visible, are present on the intermediate-focus-facing surface 857 of the head 830. Apertures 848 in the conical surface 834c extend more or less perpendicularly to the conical surface 834c, so that the apertures 848 are configured to create, when in use and supplied with a flow of gas through a passage in the shaft 829 of the obscuration bar 827 (the passage not shown in FIGS. 8A-8C but see, e.g., passage 347 of FIG. 3), a radially extending gas curtain with a flow direction including a radial component perpendicular to and away from an optical axis A. and an axial component parallel to the optical axis A and away from an intermediate focus (intermediate focus not shown but see, e.g., FIGS. 1A-1E) of the source vessel 811, as shown by the arrows in FIGS. 8C and 8B. The resulting gas curtain is thus essentially in the form of a conical fan extending outward from the exposed surface 834 of the head 830 toward the interior surface 856 of the source vessel 811. As in implementations discussed above, apertures are not positioned on or in a side surface 834i of the head 830.

The head 830 shown in FIGS. 8A-8C can be beneficially used in source vessels that include a plurality of exhaust openings extending through the source vessel, such as source vessel 811 of FIGS. 8B and 8C in which there are two exhaust ports 833a, 833b and two corresponding exhaust openings 855a, 855b on opposite sides of the source vessel 811. The shaft 829 and the base 828 of the obscuration bar can support the head 830 as shown in FIG. 8C.

FIG. 9, a cross section from the same point of view as in FIG. 8C, shows an implementation of a source vessel 911 having four exhaust ports 933a-933d and four corresponding exhaust openings 955a-955d. (The base and shaft of the obscuration bar are omitted from FIG. 9 for clearer viewing of the features shown.) The head 930 again has an exposed surface 934 in the form of a conical surface 934c, and produces, when in use, a gas curtain essentially in the form of a conical fan (represented by the arrows in FIG. 9) extending outward from the exposed surface of the head 930 toward the interior surface 956 of the source vessel 911. An exposed surface 834, 934 in the form of a conical surface, such as conical surfaces 834c, 934c, helps diffuse and/or widely distribute (i.e., avoid concentrating) power from a source laser (such as source laser 112 of FIG. 1A) that reaches the head 930. Other surface shapes can be used, and apertures such as apertures 848, even if extending within an exposed surface 834, 934 other than a conical surface, can nonetheless still lie along directions selected to produce a radially extending gas curtain such as shown by the arrows in FIGS. 8C and 9.

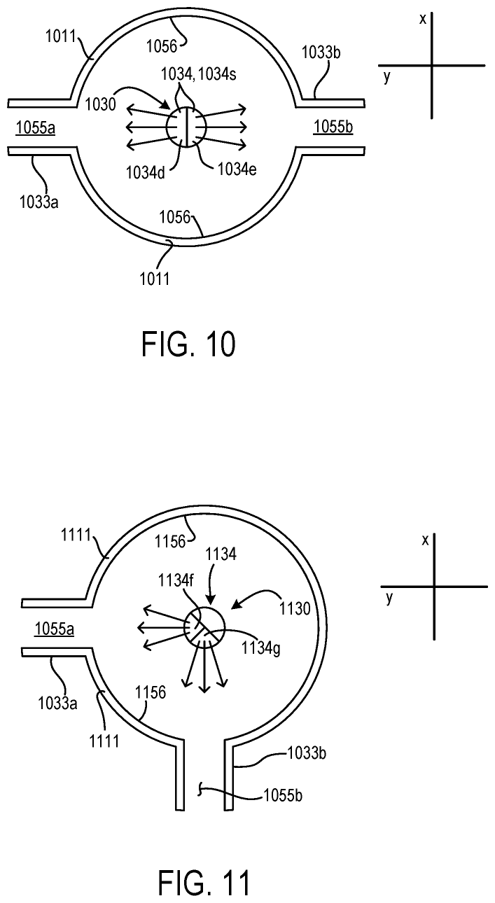

Additional implementations are shown in the cross sections of FIG. 10 and FIG. 11, with views taken similarly to those of FIGS. 8C and 9.

In the implementation shown in FIG. 10, a source vessel 1011 having an interior surface 1056 includes a plurality of exhaust ports—in this case two, 1033a, 1033b, having a corresponding plurality of exhaust openings 1055a, 1055b, extending through the source vessel 1011, similar to source vessel 811 of FIG. 8. A head 1030 of an obscuration bar (supported on a shaft not shown in the figure for case of viewing of the features shown) has two slanted facets 1034c, 1034d, on an exposed surface 1034 in the form of a slanted surface (or double slanted surface) 1034s of the head 1030. The facets each have apertures (not shown) which are configured to create, when in use and supplied with a flow of gas from a passage in or on the supporting shaft (not shown, but see FIG. 3 and the associated description above), respective gas curtains for each respective one of the plurality of exhaust gas openings 1055a, 1055b in the source vessel 1011. In the case of the implementation shown, two gas curtains are created as represented by the two sets of arrows.

In the implementation shown in FIG. 11, a source vessel 1111 having an interior surface 1156 includes a plurality of exhaust ports-again in this case two, 1133a, 1133b, having a corresponding plurality of exhaust openings 1155a, 1155b, extending through the source vessel 1111, similar to source vessel 811 of FIG. 8, except the exhaust ports 1133a, 1133b and exhaust openings 1155a, 1155b, are not arranged symmetrically within the source vessel 1111. In this implementation, a head 1130 of an obscuration bar (supported on a shaft not shown in the figure) has two facets 1134f, 1134g, on an exposed surface 1134 of the head 1130. The facets 1134f, 1134g are each positioned to face at least partially in the direction of a respective one of the plurality of exhaust openings 1155a, 1155b. Each facet has apertures (not shown) which are configured to create, when in use and supplied with a flow of gas from a passage in or on the supporting shaft (not shown), respective gas curtains extending from the exposed surface 1134 and directed toward each respective one of the plurality of exhaust gas openings 1155a, 1155b, in the source vessel 1011. In the case of the implementation shown, two gas curtains are created as represented by the two sets of arrows.

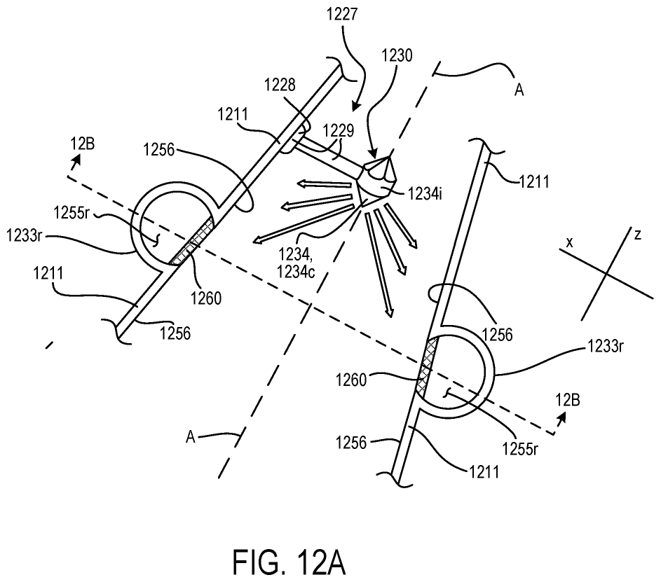

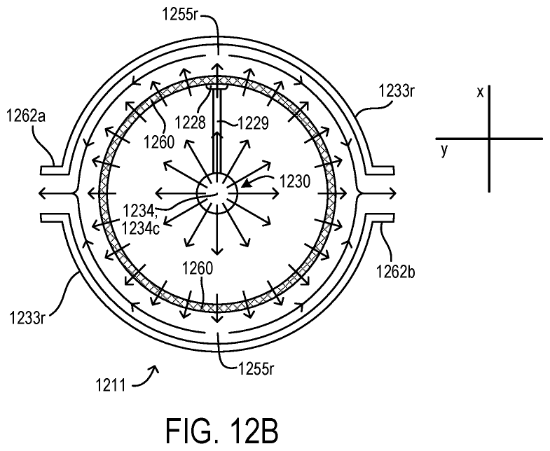

FIG. 12A shows a partial cross-section of another implementation of a source vessel 1211 of an EUV source, the source vessel 1211 having an interior surface 1256. FIG. 12B is a cross section of FIG. 12A taken along the line 12B as indicated in FIG. 12A. With reference to FIGS. 12A and 12B, the source vessel 1211 includes a ring-shaped exhaust port 1233r with an associated ring-shaped exhaust opening 1255r encircling the source vessel 1211 and extending through the source vessel, with the ring-shaped exhaust opening positioned, measured along the optical axis A, between the collector (not shown, see, e.g., FIGS. 1A-1E) and the head 1230. The exhaust opening 1233r includes a ring-shaped scrubber 1260. As shown in FIG. 12B, exhaust received in the ring-shaped exhaust opening 1255r through the ring-shaped scrubber 1260 is removed through one or more vacuum ports (two in this implementation) 1262a, 1262b connected to one or more vacuum pumps (not shown), as represented by the arrows within the ring-shaped exhaust opening 1255r and within the vacuum ports 1262a, 1262b, and through the ring-shaped scrubber 1260.

An obscuration bar 1227 in FIGS. 12A and 12B, including a head 1230 supported on a shaft 1229 which can include a base 1228, can be implemented in a same or similar way as in FIGS. 8A-8C, with an exposed surface 1234 on the head 1230 in the form of a conical surface 1234c. Apertures (not shown) in the conical surface 1234c can be configured to create, when in use and supplied with a flow of gas through a passage (not shown) in the shaft 1229, a gas curtain extending radially from the exposed surface 1234, with a flow direction including a radial component perpendicular to and away from the optical axis A and an axial component parallel to the optical axis and away from the intermediate focus, as represented by the arrows in FIG. 12A and near the center of FIG. 12B. As with other implementations discussed above, apertures are not positioned on a side surface 1234i of the head 1230.

The aspects and implementations can be further described using the following clauses:

1. An extreme ultraviolet (EUV) source including:
a source vessel, enclosing at least in part a volume in which, when in use, EUV light is transmitted by a collector from a primary focus to an intermediate focus along an optical axis;
a shaft, the shaft having a length extending from a first end to a second end of the shaft, the shaft including a passage, the passage extending at least partially along the length of the shaft, the first end of the shaft attached to an interior surface of the source vessel and the second end positioned inside the source vessel;
a head connected to the second end of the shaft, the head intersecting the optical axis, the head having an exposed surface exposed to the primary focus, the exposed surface having one or more apertures therein, the one or more apertures being in fluid communication with the passage.
   2. The EUV source of clause 1 wherein the exposed surface is a slanted surface.
   3. The EUV source of clause 1 wherein the one or more apertures are oriented along one or more directions having a component in a direction along the optical axis away from the intermediate focus and a component perpendicular to the optical axis.
   4. The EUV source of clause 1 wherein the one or more apertures include a plurality of nested ring-shaped apertures.
   5. The EUV source of clause 1 wherein the one or more apertures include a plurality of non-overlapping holes.
   6. The EUV source of clause 1 wherein the head is integral with the shaft.
   7. The EUV source of clause 1 wherein the head has a cross section, taken perpendicular to the optical axis, which is circular and centered on the optical axis.
   8. The EUV source of clause 1 wherein the head and the shaft include a refractory material.
   9. The EUV source of clause 8 wherein the refractory material is a refractory metal.
   10. The EUV source of clause 9 wherein the refractory metal is tungsten.
   11. The EUV source of clause 1 wherein the source vessel includes an exhaust opening extending through the source vessel with the exhaust opening positioned, measured along the optical axis, between the collector and the head.
   12. The EUV source of clause 11 wherein the exposed surface is a slanted surface facing generally in the direction of the exhaust opening and/or in the direction of a portion of the interior surface of the source vessel on an intermediate focus side of the exhaust opening.
   13. The EUV source of clause 11 wherein the apertures are configured to create, when in use and supplied with a flow of gas through the passage, a gas curtain having a flow direction from the exposed surface of the head toward an edge of the exhaust opening nearest the intermediate focus and/or toward a portion of the interior surface of the source vessel adjacent the edge of the exhaust opening nearest the intermediate focus.
   14. The EUV source of clause 11 wherein the flow direction of the gas curtain has component along the optical axis away from the intermediate focus.
   15. The EUV source of clause 1 wherein the head has no surfaces perpendicularly facing the intermediate focus.
   16. The EUV source of clause 1 wherein the shaft has no surfaces perpendicularly facing the intermediate focus.
   17. The EUV source of clause 1 further including:
a target delivery system configured and positioned to deliver targets including a target material to a primary focus of the collector; and
a laser configured and positioned to produce a pulsed light beam having a beam waist at or near the primary focus of the collector.
   18. The EUV source of clause 17 wherein the target material includes xenon, lithium, or tin.
   19. The EUV source of clause 18 wherein the target material includes tin.
   20. The EUV source of clause 18 further including a supply of a gas connected to the passage, the gas including an inert gas or hydrogen.
   21. The EUV source of clause 20 wherein the gas includes hydrogen.
   22. The EUV source of clause 17 wherein the collector includes a central aperture positioned to allow passage of the pulsed light beam along the optical axis toward the primary and intermediate foci of the collector.
   23. The EUV source of clause 22 wherein the head is positioned such that no direct light from the primary focus is reflected by the collector to the head.
   24. The EUV source of clause 23 wherein the head shields the intermediate focus from direct light from the pulsed light beam.
   25. The EUV source of clause 17 wherein the head has an anti-reflection and/or a diffusive geometry facing the primary focus of the collector such that the pulsed light beam is reflected in a diffuse manner from the head rather than concentrated at any location within the source vessel.
   26. The EUV source of clause 25 wherein the anti-reflection and/or diffusive geometry of the head includes a generally convex surface.
   27. The EUV source of clause 17 wherein the shaft has no surfaces perpendicularly facing the intermediate focus.
   28. The EUV source of clause 1 wherein the shaft has no surfaces perpendicularly facing the primary focus.
   29. The EUV source of clause 1 wherein the shaft has an elongated cross section when taken in a plane parallel to the optical axis and perpendicular to the length of the shaft, with a long dimension of the cross section lying in a direction generally parallel to the optical axis, and wherein a cross section of the passage in a plane parallel to the optical axis and perpendicular to the length of the shaft is elongated a direction generally parallel to the optical axis.
   30. The EUV source of clause 1 further including:
a target delivery system configured and positioned to deliver targets including a target material to the primary focus of the collector, the target delivery system including a shroud shielding a path toward the primary focus of the collector,
wherein an image of the shaft is aligned with an image of the shroud when viewed from the primary focus of the collector in reflection from the collector surface.
   31. The EUV source of clause 30 wherein the image of the shaft is hidden by the image of the shroud when viewed from the primary focus of the collector in reflection from the collector surface.
   32. The EUV source of clause 31 wherein the shaft has an elongated cross section when taken in a plane parallel to the optical axis and perpendicular to the length of the shaft, with a long dimension of the cross section lying in a direction generally parallel to the optical axis.
   33. The EUV source of clause 1 wherein the source vessel includes one exhaust opening extending through one side of the source vessel with the exhaust opening positioned, measured along the optical axis, between the collector and the head.
   34. The EUV source of clause 1 wherein the source vessel includes a plurality of exhaust openings extending through the source vessel with the exhaust openings positioned, measured along the optical axis, between the collector and the head.
   35. The EUV source of clause 34 wherein the apertures are configured to create, when in use and supplied with a flow of gas through the passage, respective gas curtains for each respective one of the plurality of exhaust gas openings, the respective gas curtains having respective flow directions from the exposed surface of the head toward an edge nearest the intermediate focus of the respective one of the plurality of exhaust openings and/or toward a portion of the interior surface of the source vessel adjacent the edge nearest the intermediate focus of the respective exhaust opening.
   36. The EUV source of clause 34 wherein the apertures are configured to create, when in use and supplied with a flow of gas through the passage, a radially extending gas curtain extending from the exposed surface of the head with a flow direction including a radial component perpendicular to and away from the optical axis and an axial component parallel to the optical axis and away from the intermediate focus.
   37. The EUV source of clause 1 wherein the source vessel includes a ring-shaped exhaust opening encircling the source vessel and extending through the source vessel with the ring-shaped exhaust opening positioned, measured along the optical axis, between the collector and the head.
   38. The EUV source of clause 37 wherein the apertures are configured to create, when in use and supplied with a flow of gas through the passage, a radially extending gas curtain extending from the exposed surface of the head with a flow direction including a radial component perpendicular to and away from the optical axis and an axial component parallel to the optical axis and away from the intermediate focus.
   39. A method of reducing or preventing deposition on an interior of a source vessel in an extreme ultraviolet (EUV) light source, the method including:
supplying a gas to a passage in an obscuration bar including a shaft and a head, a first end of the shaft supported on an interior surface of a source vessel in an EUV light source, the source vessel surrounding an optical axis of the EUV light source, the optical axis extending from a collector through a primary focus to an intermediate focus of the EUV light source, a head of the obscuration bar at a second end of the shaft intersecting the optical axis, the head having an exposed surface exposed to the primary focus; and
flowing the gas out through one or more apertures in the exposed surface of the head of the obscuration bar, the one or more apertures in fluid communication with the passage.
   40. The method of clause 39 wherein the exposed surface is a slanted surface.
   41. The method of clause 39 wherein the one or more apertures are oriented along one or more directions having a component in a direction along the optical axis away from the intermediate focus and a component perpendicular to the optical axis.
   42. The method of clause 39 wherein the head is integral with the shaft of the obscuration bar.
   43. The method of clause 39 wherein the head has a cross section, taken perpendicular to the optical axis, which is circular and centered on the optical axis.
   44. The method of clause 39 wherein the head has no surfaces perpendicularly facing the intermediate focus.
   45. The method of clause 39 wherein the head and the shaft include a refractory material.
   46. The method of clause 39 wherein the refractory material is a refractory metal.
   47. The method of clause 43 wherein the refractory metal is tungsten.
   48. The method of clause 39 wherein the source vessel includes an exhaust opening extending through the source vessel with the exhaust opening positioned, measured along the optical axis, between the collector and the head, the method further including flowing gas from inside the source vessel through the exhaust opening.
   49. The method of clause 48 wherein the exposed surface is a slanted surface facing generally in the direction of the exhaust opening and/or in the direction of a portion of the interior surface of the source vessel on an intermediate focus side of the exhaust opening.
   50. The method of clause 48 further including generating a gas curtain including the gas flowing out through one or more apertures in the exposed surface of the head, the gas curtain extending from the exposed surface of the head to the exhaust opening and/or to a portion of the inside surface of the source vessel on the intermediate focus side of the exhaust opening.
   51. The method of clause 50 wherein the gas curtain extends along a direction having a component along the optical axis away from the intermediate focus.
   52. The method of clause 50 further including introducing an intermediate-focus-protecting gas flow at or near the intermediate focus flowing toward the collector along the optical axis.
   53. The method of clause 52 wherein generating the gas curtain includes splitting the intermediate-focus-protecting gas flow at the head and joining the intermediate-focus-protecting gas flow with the gas flowing out through one or more apertures in the exposed surface of the head to form the gas curtain.
   54. The method of clause 50 further including:
delivering targets including a target material to the primary focus of the collector, the target material having a melting point;
irradiating the targets with light pulses at the primary focus of the collector to form a plasma at the primary focus of the collector, the plasma emitting EUV light; and maintaining at least portion of the source vessel at a temperature or temperatures below the melting point of the target material.
   55. The method of clause 54 wherein maintaining at least portion of the source vessel at a temperature or temperatures below the melting point of the target material includes maintaining at least a portion of the source vessel at a temperature within the range of from 50 C to 200 C.
   56. The method of clause 39 wherein flowing the gas out through one or more apertures in the exposed surface of the head of the obscuration bar includes suppressing or preventing a flow of gas in a direction away from the collector from passing an exhaust opening, causing the flow of gas in a direction away from the collector to enter the exhaust opening.
   57. The method of clause 51 including suppressing or preventing the flow of gas in a direction away from the collector from passing the exhaust opening during a time period extending 20 milliseconds from stopping irradiating targets with light pulses in the source vessel.
   58. The method of clause 51 including suppressing or preventing the flow of gas in a direction away from the collector from passing the exhaust opening during a time period extending 20 milliseconds from starting irradiating targets with light pulses in the source vessel.

The above-described implementations and other implementations are within the scope of the following claims.

1. An extreme ultraviolet (EUV) source comprising:
a source vessel enclosing, at least in part, a volume in which, when in use, EUV light is transmitted by a collector from a primary focus to an intermediate focus along an optical axis;
a shaft having a length extending from a first end to a second end of the shaft, the shaft including a passage, the passage extending at least partially along the length of the shaft, the first end of the shaft attached to an interior surface of the source vessel and the second end positioned inside the source vessel; and
a head connected to the second end of the shaft, the head intersecting the optical axis, the head having an exposed surface exposed to the primary focus, the exposed surface having one or more apertures therein, the one or more apertures being in fluid communication with the passage.

2. The EUV source of claim 1 wherein the exposed surface is a slanted surface.

3. The EUV source of claim 1 wherein the one or more apertures are oriented along one or more directions having a first component in a direction along the optical axis away from the intermediate focus and a second component perpendicular to the optical axis.

4. (canceled)

5. The EUV source of claim 1 wherein the one or more apertures comprise a plurality of non-overlapping holes.

6. (canceled)

7. The EUV source of claim 1 wherein the head has a cross section, taken perpendicular to the optical axis, which is circular and centered on the optical axis.

8. The EUV source of claim 1 wherein the head and the shaft comprise a refractory material.

9. (canceled)

10. The EUV source of claim 8 wherein the at least one of the head and the shaft includes tungsten.

11. The EUV source of claim 1 wherein the source vessel comprises an exhaust opening extending through the source vessel with the exhaust opening positioned, measured along the optical axis, between the collector and the head.

12. The EUV source of claim 11 wherein the exposed surface is a slanted surface facing generally in the direction of the exhaust opening and/or in the direction of a portion of the interior surface of the source vessel on an intermediate focus side of the exhaust opening.

13. The EUV source of claim 11 wherein the apertures are configured to create, when in use and supplied with a flow of gas through the passage, a gas curtain having a flow direction from the exposed surface of the head toward an edge of the exhaust opening nearest the intermediate focus and/or toward a portion of the interior surface of the source vessel adjacent the edge of the exhaust opening nearest the intermediate focus.

14. (canceled)

15. The EUV source of claim 1 wherein the head has no surfaces perpendicularly facing the intermediate focus.

16.-28. (canceled)

29. The EUV source of claim 1 wherein the shaft has an elongated cross section when taken in a plane parallel to the optical axis and perpendicular to the length of the shaft, with a long dimension of the cross section lying in a direction generally parallel to the optical axis, and wherein a cross section of the passage in a plane parallel to the optical axis and perpendicular to the length of the shaft is elongated a direction generally parallel to the optical axis.

30.-38. (canceled)

39. A method of reducing or preventing deposition on an interior of a source vessel in an extreme ultraviolet (EUV) light source, the method comprising:
supplying a gas to a passage in an obscuration bar comprising a shaft and a head, a first end of the shaft supported on an interior surface of a source vessel in an EUV light source, the source vessel surrounding an optical axis of the EUV light source, the optical axis extending from a collector through a primary focus to an intermediate focus of the collector, the head of the obscuration bar at a second end of the shaft, intersecting the optical axis, and having an exposed surface; and
flowing the gas out through one or more apertures in the exposed surface of the head of the obscuration bar, the one or more apertures in fluid communication with the passage.

40.-47. (canceled)

48. The method of claim 39 wherein the source vessel comprises an exhaust opening extending through the source vessel with the exhaust opening positioned, measured along the optical axis, between the collector and the head, the method further comprising flowing gas from inside the source vessel through the exhaust opening.

49. (canceled)

50. The method of claim 48 further comprising generating a gas curtain comprising flowing the gas out through one or more apertures in the exposed surface of the head, the gas curtain extending from the exposed surface of the head to the exhaust opening and/or to a portion of the inside surface of the source vessel on the intermediate focus side of the exhaust opening.

51. (canceled)

52. The method of claim 50 further comprising introducing an intermediate-focus-protecting gas flow at or near the intermediate focus flowing toward the collector along the optical axis.

53. The method of claim 52 wherein generating the gas curtain comprises splitting the intermediate-focus-protecting gas flow at the head and joining the intermediate-focus-protecting gas flow with the gas flowing out through one or more apertures in the exposed surface of the head to form the gas curtain.

54. The method of claim 50 further comprising:
delivering targets comprising a target material to the primary focus of the collector, the target material having a melting point; and
irradiating the targets with light pulses at the primary focus of the collector to form a plasma at the primary focus of the collector, the plasma emitting EUV light; and
maintaining at least portion of the source vessel at a temperature or temperatures below the melting point of the target material.

55. The method of claim 54 wherein maintaining at least portion of the source vessel at a temperature or temperatures below the melting point of the target material comprises maintaining at least a portion of the source vessel at a temperature within the range of from 50° C. to 200° C.

56. The method of claim 39 wherein flowing the gas out through one or more apertures in the exposed surface of the head of the obscuration bar comprises suppressing or preventing a flow of gas in a direction away from the collector from passing an exhaust opening, causing the flow of gas in a direction away from the collector to enter the exhaust opening.

57. (canceled)

58. (canceled)
